(19) United States
(12) Patent Application Publication
(10) Pub. No.: US 2006/0269468 A1
(43) Pub. Date: Nov. 30, 2006

(54) Apparatus and method for mass production of carbon nanotubes

(76) Inventors: Sang-Moon Chung, Gyeonggi-do (KR); Heon Ham, Gyeonggi-do (KR)

Correspondence Address: CARSTENS & CAHOON, LLP, P O BOX 802334, DALLAS, TX, 75380, US

(21) Appl. No.: 11/202,156

(22) Filed: Aug. 11, 2005

(30) Foreign Application Priority Data
May 26, 2005 (KR) 10-2005-0044461
May 26, 2005 (KR) 10-2005-0044471

(51) Int. Cl. D01F 9/12; B01J 19/00

(52) U.S. Cl. 423/447.3; 422/150; 422/153; 422/198

(57) ABSTRACT

The present invention relates to an apparatus and method for mass production of carbon nanotubes. More specifically, it relates to an apparatus and method for mass production of carbon nanotubes, which are capable of achieving mass synthesis of carbon nanotubes and simultaneous production of various structures of carbon nanotubes, by a manner that a plurality of independent reaction chambers are configured, and a heater supplying temperatures necessary for reaction in the corresponding reaction chambers is configured to have a plurality of reaction temperature sections, such that the heater moves according to reaction steps in the respective reaction chambers under different reaction steps and matches reaction temperature sections to thereby continuously provide proper reaction temperatures to the respective reaction chambers and at the same time, to stably supply and discharge reaction gases and stabilizing gases necessary for the respective reaction steps to and from respective reaction chambers, in order to continuously produce carbon nanotubes.

### BACKGROUND OF THE INVENTION

1. Field of the Invention

The present invention relates to an apparatus and method for mass production of carbon nanotubes. More specifically, it relates to an apparatus and method for mass production of carbon nanotubes, which are capable of continuously producing carbon nanotubes in plural reaction sections via use of a heater having a multiplicity of reaction temperature zones.

2. Description of the Related Art

As the current representative technical methods for preparing carbon nanotubes, mention may be made of arc discharge, laser vaporization and thermal chemical vapor deposition. In addition, carbon nanotubes may also be prepared using several other methods. Among these methods, synthesis of carbon nanotubes via use of the representatively well-known thermal chemical vapor deposition is briefly described as follows.

Thermal chemical vapor deposition is a method involving passing a gaseous carbon component into a high-temperature reactor to induce spontaneous generation of carbon nanotubes, utilizing a catalyst and high temperatures of 600 to 1000° C. However, this method suffers from disadvantages such as heterogeneous supply of gas occurring according to changes in flow rate of reaction gas in the reactor, thus leading to poor uniformity in a substrate, and susceptibility of reaction conditions to position and changes in temperature of the reactor. In addition, the thermal chemical vapor deposition employs a simplified apparatus and is relatively advantageous for mass synthesis, but is not feasible for actual mass production of carbon nanotubes.

In particular, conventional thermal chemical vapor deposition apparatuses have drawbacks such as low productivity of carbon nanotubes per unit time due to the very long period of time consumed to raise and lower the temperature of the heater for supplying heat, and incapability to achieve mass production of carbon nanotubes due to difficulty in continuous supply of the catalyst to the inside of the reaction apparatus. Further, conventional mass synthesis apparatuses via application of such thermo-chemical apparatuses also present a great deal of problems associated with stable temperature control and gas supply necessary for reaction and thus suffer from difficulty in application thereof to practical production processes.

Consequently, use of the conventional thermal chemical vapor deposition in synthesis of carbon nanotubes gives rise to difficulties in mass production and thus increased production costs.

### SUMMARY OF THE INVENTION

Therefore, the present invention has been made in view of the above problems, and it is an object of the present invention to provide an apparatus and method for mass production of carbon nanotubes, which is capable of performing stable operation of reaction temperatures and gases by installing a heater, a heater-driving device and a plurality of reaction chambers and is capable of realizing mass production processes by means of continuous synthesis of carbon nanotubes through continuous supply of a catalyst.

Another object of the present invention is to provide an apparatus and method for mass production of carbon nanotubes, which is capable of producing various structures of carbon nanotubes such as multi-walled carbon nanotubes (MWCNTs), double-walled carbon nanotubes (DWCNTs) and single-walled carbon nanotubes (SWCNTs) depending upon desired uses, by allowing for reaction of reaction gases with the catalysts at the stable temperature within easy unit chamber during operation of plural chambers.

In accordance with a first aspect of the present invention, the above and other objects can be accomplished by the provision of an apparatus for mass production of carbon nanotubes, comprising:

a plurality of reaction chambers where synthesis of carbon nanotubes is performed by reaction of reaction gases with catalysts via internal reactors;

a heater having different temperature zones sectioned according to respective synthetic steps of carbon nanotubes and simultaneously providing reaction temperatures for the respective steps necessary for synthesis of carbon nanotubes to the reaction chambers;

a driving device for driving the heater such that positions of the temperature zones for the respective synthesis steps of the heater are moved to the corresponding reaction chambers of the respective synthesis steps, and for moving the heater at a predetermined interval of time in compliance with progress of the synthesis steps such that carbon nanotubes are continuously synthesized in respective reaction chambers; and

gas supply and discharge sections for supplying and discharging reaction gases corresponding to respective synthesis steps to and from internal reactors of the respective reaction chambers in compliance with movement control of the driving device according to the respective synthesis steps.

In accordance with a second aspect of the present invention, there is provided an apparatus for mass production of carbon nanotubes, comprising:

a plurality of reaction chambers where synthesis of carbon nanotubes is performed by reaction of reaction gases with catalysts via internal reactors;

a heater having different temperature zones sectioned according to respective synthesis steps of carbon nanotubes and simultaneously providing reaction temperatures for the respective synthesis steps necessary for synthesis of carbon nanotubes to the reaction chambers;

a driving device for driving the reaction chambers such that positions of the reaction chambers are moved to temperature zones of the heater corresponding to the internal synthesis steps, and for moving the reaction chambers at a predetermined interval of time in compliance with progress of the synthesis steps such that carbon nanotubes are continuously synthesized in respective reaction chambers; and

gas supply and discharge sections for supplying and discharging reaction gases corresponding to respective synthesis steps to and from internal reactors of the respective reaction chambers, in compliance with movement control of the driving device according to the respective synthesis steps.

In accordance with a third aspect of the present invention, there is provided a method for mass production of carbon nanotubes, comprising:

driving a heater composed of at least one low-temperature zone, at least one reaction zone and at least one cooling zone to move the positions of low-temperature zones of the heater to corresponding reaction chambers, and subjecting the corresponding reaction chambers to argon atmosphere using argon gas prepared in a gas mixer to thereby discharge internal air to the outside (preheating step);

driving the heater to move the positions of high-temperature zones thereof to corresponding reaction chambers, and replacing the argon gas in the reaction chambers with carbonization gas prepared in the gas mixer to synthesize carbon nanotubes via reaction between the carbonization gas and catalyst (reaction step); and

driving the heater to move the positions of the cooling zones thereof to the corresponding reaction chambers, and discharging the remaining gas in the chambers to the outside by action of argon gas prepared in the gas mixer and cooling the synthesized carbon nanotubes in reaction chambers (cooling step).

Further, in accordance with a fourth aspect of the present invention there is provided a method for mass production of carbon nanotubes, comprising:

driving reaction chambers to move the positions thereof to low-temperature zones of a heater composed of at least one low-temperature zone, at least one reaction zone and at least one cooling zone, and subjecting the corresponding reaction chambers to argon atmosphere using argon gas prepared in a gas mixer to thereby discharge internal air to the outside (preheating step);

driving the reaction chambers to move the positions thereof to high-temperature zones of the heater, and replacing the argon gas in the reaction chambers with carbonization gas prepared in the gas mixer to synthesize carbon nanotubes via reaction between the carbonization gas and catalyst (reaction step); and

driving the reaction chambers to move the positions thereof to the cooling zones of the heater, and discharging the remaining gas in the chambers to the outside by action of argon gas prepared in the gas mixer and cooling the synthesized carbon nanotubes in reaction chambers (cooling step).

### BRIEF DESCRIPTION OF THE DRAWINGS

The above and other objects, features and other advantages of the present invention will be more clearly understood from the following detailed description taken in conjunction with the accompanying drawings, in which:

FIG. 1 schematically shows a mass synthesis apparatus for mass production of carbon nanotubes in accordance with the present invention;

FIG. 2 schematically shows synthesis processes for mass production of carbon nanotubes in accordance with the present invention; and

FIG. 3 shows another embodiment of a mass synthesis apparatus for mass production of carbon nanotubes in accordance with the present invention.

### DESCRIPTION OF THE PREFERRED EMBODIMENTS

Hereinafter, the preferred embodiments of the present invention will be described in more detail with reference to the accompanying drawings.

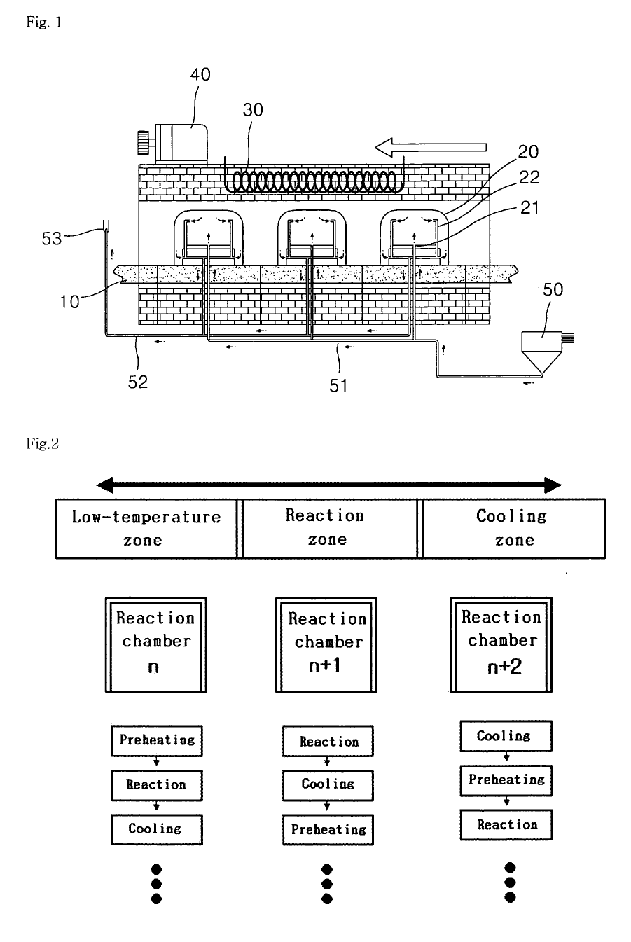

FIG. 1 is a schematic constitutional view of an apparatus for mass production of carbon nanotubes to which the present invention is applied.

The mass synthesis apparatus for mass production of carbon nanotubes, to which the present invention is applied, includes a plurality of reaction chambers 20 in which separate synthesis steps for synthesizing carbon nanotubes are individually carried out; a heater 30 moving around reaction chambers 20 while providing temperatures necessary for synthesis reaction in the reaction chambers 20; a driving motor 40 for driving the heater 30 such that the heater 30 moves along sections where the reaction chambers 20 are arranged; and gas supply and discharge sections 50, 51, 52 and 53 for stably supplying and discharging reaction gases necessary for synthesis reaction to and from the reaction chambers 20.

The reaction chambers 20 are installed in plural number on a ceramic plate 10 as a base plate, and the catalysts and gases individually perform various processes for production of carbon nanotubes in respective internal reactors.

That is, synthesis steps for production of carbon nanotubes are separately carried out in a multiplicity of reaction chambers 20.

Herein, synthesis steps for production of carbon nanotubes involve preheating, reaction and cooling steps, and the respective reaction chambers 20 individually carry out any one step of the respective synthesis steps.

Temperature supply for respective synthesis steps in reaction chambers 20 is performed by the heater 30. The heater 30 is configured to have three divided zones, i.e., a low temperature zone, a reaction zone and a cooling zone such that supply of various temperatures to reaction chambers 20 can be achieved according to respective synthesis steps, thereby stabilizing temperatures for the overall synthesis processes of carbon nanotubes.

In this connection, the low-temperature zone of the heater 30 stably supplies a temperature of 100° C. to 700° C. to the reaction chamber 20 carrying out the preheating step. In addition, the reaction zone of the heater 30 stably supplies a temperature of 800° C. to 1000° C. to the reaction chamber 20 carrying out the reaction step. Finally, the cooling zone of the heater 30 stably supplies a temperature of 700° C. to 200° C. to the reaction chamber 20 carrying out the cooling step.

As such, the heater 30, which provides suitable reaction temperatures to plural reaction chambers 20, is connected to the driving motor 40 and moves at a predetermined interval of time along the sections where a plurality of reaction chambers 20 containing catalysts are installed, thereby continuously progressing synthesis processes in respective reaction chambers 20.

That is, the heater 30 having the low temperature zone, reaction zone and cooling zone moves at a predetermined interval of time along the sections where reaction chambers 20 are installed, by driving the driving motor 40. Herein, the position of the driving motor 40 is controlled such that the low temperature zone of the heater 30 can stably supply the necessary temperature for reaction to the reaction chamber 20 carrying out the preheating step. Similarly, the driving motor 40 also controls the reaction zone of the heater 30 to be positioned toward the reaction chamber 20 carrying out the reaction step, and controls the cooling zone to be positioned toward the reaction chamber 20 carrying out the cooling step.

As a plurality of reaction chambers 20 progress separate synthesis steps as mentioned above, it is possible to prevent the reaction gases according to the respective synthesis steps from being mixed with the stabilizing gas, and the gases in the respective reaction chambers 20 are stabilized without being mixed with those of other reaction chambers.

More specifically, operations of the reaction gases according to synthesis steps are as follows.

For stable operation of reaction gases according to temperatures, the mass synthesis apparatus for mass production of carbon nanotubes in accordance with the present invention carries out a preheating process in which the catalyst is stably melted in a temperature range of 200 to 700° C. under argon atmosphere, a reaction process of synthesizing carbon nanotubes via reaction with the catalyst by supplying a hydrocarbon such as methane gas, acetylene gas, or ethylene gas at flow rate of 10 to 1,000 sccm in a temperature range of 800 to 1000° C., and a cooling process of sharply lowering the temperature of the reaction chambers to a temperature of 700 to 200° C. under argon atmosphere, after completion of reaction.

Herein, gas supply and discharge sections 50, 51, 52 and 53 stably mix various gases and then supply the mixed gases to respective reaction chambers 20 and discharge exhaust gas.

More specifically, with reference to FIG. 1, the gas mixer 50 stably mixes and discharges gases necessary for the respective synthesis steps of reaction chambers 20. The gases thus-discharged from the gas mixer 50 are delivered via the gas suppliers 51 to the gas diffusion ports 21 installed at lower parts of the reaction chambers 20, and the gas diffusion ports 21 in turn diffuse the delivered gases at the lower parts of the reaction chambers 20.

After completion of reaction, the reaction gases are exhausted through gas exhaust ports 22 installed at upper and lower parts in the reaction chambers 20, and the gas discharge devices 52 receive and discharge the exhausted gases to the outside. The thus-discharged gases are burned by the exhaust gas combustor 53 and then discharged to the atmosphere.

Herein, the gas suppliers 51 and gas discharge devices 52 in the chambers are gas pipes made of high-purity aluminum, and control gas supply and discharge and thereby gases can be stably operated in the chambers.

That is, division of the reaction sections into a plurality of chamber regions not only enables control for synthesis of carbon nanotubes suited for production purpose of gas in the respective chambers, but can also stabilize the gases such that there is no mixing of reaction gases between the respective reaction sections, i.e., reaction chambers.

Accordingly, the reaction chambers 20, which are the respective reaction sections, will stably produce desired reaction under given conditions without being affected by gases from other reaction chambers 20. In addition, due to stable supply of gases suited for desired purpose to the respective reaction chambers 20, synthesis processes for various structures of carbon nanotubes, such as multi-walled carbon nanotubes (MWCNTs), double-walled carbon nanotubes (DWCNTs) and single-walled carbon nanotubes (SWCNT) can be individually progressed in the respective reaction chambers 20.

Hence, the respective reaction chambers 20 are given necessary temperatures for the respective synthesis steps from the low temperature zone, reaction zone and cooling zone of the heater 30, depending upon predetermined movement of the heater 30 along the reaction sections while receiving gases necessary for respective synthesis steps from the gas supply and discharge sections 50, 51, 52 and 53. Thereby, it is possible to achieve mass production of carbon nanotubes and also to simultaneously produce various structures of carbon nanotubes through progression of synthesis processes according to individual chambers.

Hereinafter, specific production processes are described utilizing the apparatus for mass production of carbon nanotubes having the thus-explained structure in accordance with the present invention.

Firstly, in order to proceed the preheating process among synthesis processes of carbon nanotubes, when argon gas is prepared in the gas mixer 50 and is supplied through the gas suppliers 51 to the reaction chambers 20 for a low-temperature process, the gas diffusion ports 21 in the corresponding reaction chambers 20 diffuse the supplied argon gas at the lower parts of the chambers, so that the corresponding reaction chambers 20 are subjected to an argon atmosphere (S10).

In addition, the driving motor 40 drives the heater 30 to move the low-temperature zone thereof toward the reaction chambers 20 under argon atmosphere, thereby supplying a temperature of 200 to 700° C. to the reaction chambers 20 (S20).

Consequently, the reaction catalysts are stably melted and heated to a suitable temperature for reaction in the reaction chambers 20. Herein, as argon gas also serves to push the air outside the apparatus in order to maximally inhibit component reaction with the catalyst in the air, the gas exhaust ports 22 vent the air in the corresponding chambers simultaneously from the top and bottom, and the gas discharge devices 52 receive and discharge the air to the outside (S30).

Next, in order to proceed the reaction process among synthesis processes of carbon nanotubes, the gas mixer 50 prepares carbonization gas containing carbon such as methane, acetylene and ethylene gas, and supplies the carbonization gas at 10 to 1,000 sccm to the reaction chambers 20 which have completed the low-temperature process through the gas suppliers 51. Thereby, the gas diffusion ports 21 and gas exhaust ports 22 in the reaction chambers 20 replace the low-temperature argon gas with the carbonization gas which is then diffused to the chambers (S40).

Simultaneously, the driving motor 40 drives the heater 30 to move the high-temperature zone of the heater 30 toward the reaction chambers 20 filled with the carbonization gas, and thereby a temperature of 800 to 1,000° C. is supplied to the corresponding reaction chambers 20 whereby the carbon-containing gas reacts with the catalysts to synthesize carbon nanotubes in chambers (S50).

Then, in order to proceed the cooling process among synthesis processes of carbon nanotubes, the gas mixer 50 prepares and supplies argon gas to the reaction chambers 20 for the cooling process via the gas suppliers 51 (S60).

At the same time, the driving motor 40 drives the heater 30 to move the cooling zone of the heater 30 to the reaction chambers 20 which have completed reaction. Due to the injected argon gas, the remaining gas in the reaction chambers 20 is then discharged through the gas exhaust ports 22 and gas discharge devices 52 and the carbon nanotubes synthesized in the reaction chambers 20 are cooled (S70). Therefore, the carbon nanotubes that have completed reaction can be safely cooled and recovered without being affected by the remaining gas containing carbon ingredients.

That is, upon reviewing the synthesis processes of the carbon nanotubes in accordance with the present invention as are carried out by 3-step synthesis, the chamber is first filled with argon gas and a reaction catalyst is stably heated and melted to a temperature suitable for reaction, in the low-temperature zone ranging from 200 to 700° C. of the heater 30. Herein, as argon gas also serves to push the air to the outside of the apparatus in order to maximally inhibit component reaction with the catalyst in the air.

In addition, the argon gas, which was present in the low-temperature zone of the heater 30, is replaced with gas containing carbon such as ethane and methane gas in the high-temperature zone having a temperature of 800 to 1,000° C., whereby the gas containing carbon reacts with the catalyst to form carbon nanotubes.

Finally, in the cooling zone having a temperature of 700 to 200° C., the gas remaining after completion of the reaction is discharged to the outside of the chamber via use of argon gas and the low-temperature cooling zone cools the synthesized carbon nanotubes without being affected by the remaining gas of carbon ingredients.

The above-mentioned synthesis processes of carbon nanotubes were only illustrated for synthesis processes performed in one of plural reaction chambers 20. In effect, the heater 30, as shown in FIG. 2, is sectioned into the low temperature zone, reaction zone and cooling zone according to desired temperatures. Therefore, the low-temperature zone is positioned to one of plural reaction chambers 20 to carry out the preheating process, and at the same time, the high-temperature zone and cooling zone other than the low-temperature zone are positioned to other reaction chambers 20 to simultaneously provide temperature necessary for reaction process or cooling process of the chambers 20, thereby simultaneously progressing the synthesis processes of carbon nanotubes in multiple reaction chambers 20.

That is, depending upon the position of the heater 30, synthesis of carbon nanotubes under different processes simultaneously progresses in a multiplicity of different reaction chambers 20. In addition, as the heater 30 is driven to move the position thereof at a predetermined interval of time by the driving motor 40, the proper temperatures corresponding to the progressing processes are continuously provided to plural reaction chambers 20, thereby continuously progressing synthesis of carbon nanotubes.

Hence, the heater 30, which is divided into the low temperature zone, reaction zone and cooling zone according to corresponding temperatures, moves over more than 3 regularly arranged reaction chambers 20, by driving of the driving motor 40 and provides the proper temperatures corresponding to the progressing processes. Corresponding to the movement of the heater 30, gases repeatedly enter and exit reaction chambers 20 sequentially from gas supply and discharge sections 50, 51, 52 and 53, thereby simultaneously progressing different synthesis processes according to reaction chambers leading to continuous mass synthesis of carbon nanotubes.

Herein, even though the heater 30 is illustrated to have three divided zones composed of the low temperature zone, reaction zone and cooling zone as described and shown in the above-mentioned description and drawings, the present invention is not limited to such a configuration. As such, in accordance with the present invention, the heater 30 may be composed of a plurality of low temperature zones, a plurality of reaction zones and a plurality of cooling zones and thus it is of course possible to simultaneously progress synthesis processes for numerous reaction chambers according to movement of the heater.

Further, as another embodiment of the mass synthesis apparatus for mass production of carbon nanotubes, the apparatus may take a constitution in which the heater 30, divided into three zones, the low temperature zone, reaction zone and cooling zone, is stationary and a plurality of reaction chambers 20 are connected to the driving motor 40′.

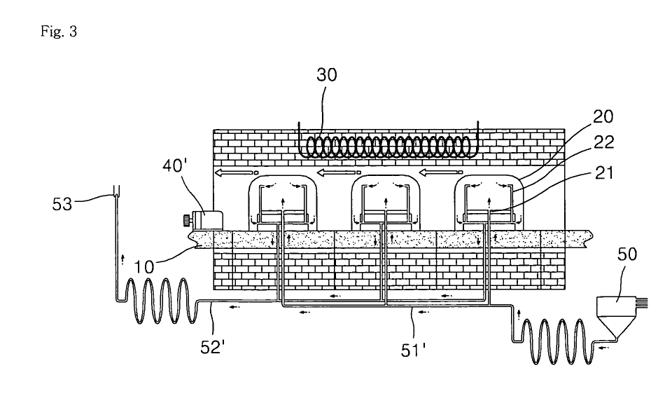

That is, as shown in FIG. 3, the heater 30 is stationary in the state in which the heater is sequentially sectioned into three zones, i.e., the low temperature zone, reaction zone and cooling zone. Therefore, a plurality of reaction chambers 20 moves sequentially in the direction of the low temperature zone, reaction zone and cooling zone of the heater 30 at a predetermined interval of time by driving of the driving motor 40′. The respective reaction chambers 20 move along the respective zones of the stationary-arranged heater 30 according to guidance of the driving motor 40′, thereby receiving proper temperatures for reaction. Corresponding to the movement of the reaction chambers 20, gases repeatedly enter and exit reaction chambers 20 sequentially from gas supply and discharge sections 50, 51′, 52′ and 53, thereby simultaneously progressing different synthesis processes according to reaction chambers leading to continuous mass synthesis of carbon nanotubes.

Such a constitution including the stationary-arranged heater 30 and movable reaction chambers 20 can be easily implemented by simply replacing control of the driving motor 40 for movement of the heater 30 with control of the driving motor 40′ for movement of the reaction chambers 20 in the synthesis processes of carbon nanotubes in accordance with the present invention.

Meanwhile, for reference, in order to synthesize carbon nanotubes utilizing the mass synthesis apparatus of the present invention, nano catalysts prepared using various techniques and methods may be employed such as a metal catalyst using a thin metal substrate or a catalyst using nanopowder. As examples of a transition metal film using the substrate, utilizable in the present invention, mention may be made of various transition metal films such as iron, nickel, cobalt, iron-nickel and cobalt-nickel. The nanopowder can be easily obtained via use of co-precipitation methods, sol-gel methods and the like, as are well-known methods for preparing nano catalyst particles.

A precipitation method of precipitating the transition metal in a solution that is generally utilized in preparation of nano catalyst particles obtains nano particles by mixing a solution containing Fe, Ni, Co or the like as metal particles with a solution of particles having pores (MgO, Al₂O₃) and precipitating the resulting mixture using aqueous ammonia or hydrochloric acid. As examples of nanopore materials that can be utilized in the present invention, mention may be made of nanopore materials such as MgO and Al₂O₃. As the solution containing the metal catalyst such as Fe, Ni or Co, Fe₂(SO₄)₃.5H₂O or Ni₂(SO₄)₃.5H₂O may be used. Upon melting the metal catalyst particles at a high temperature, molybdenum, a transition metal that is not easily melted even at high temperatures, should be mixed at a predetermined ratio into the above-mentioned solution, in order to prevent growth to large particles due to inter-binding of particles such as Fe, Ni and Co. Molybdenum can be readily obtained from the solution containing the transition metal, such (NH₄)₆Mo₇O₂₄.

As apparent from the above description, the apparatus and method for mass production of carbon nanotubes in accordance with the present invention provides effects capable of synthesizing a large quantity of carbon nanotubes above the catalyst within a short period of time, in a manner that the heater having different temperature sections corresponding to respective synthesis steps moves while providing proper temperatures to a plurality of reaction chambers according to respective synthesis steps, and reaction gases for respective synthesis steps are to be supplied and discharged such that reaction gases continuously react with catalysts in the respective reaction chambers, thereby continuously synthesizing carbon nanotubes.

Further, in accordance with the present invention, provided are effects capable of simultaneously progressing synthesis processes of various structures of carbon nanotubes such as multi-walled carbon nanotubes (MWCNTs), double-walled carbon nanotubes (DWCNTs) and single-walled carbon nanotubes (SWCNTs) without gas mixing between different reaction chambers during synthesis of carbon nanotubes in the respective reaction chambers by allowing for reaction of reaction gases with the catalyst at the stable temperature within each unit chamber during operation of plural chambers.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for mass production of carbon nanotubes, comprising:
a plurality of reaction chambers where synthesis of carbon nanotubes is performed by reaction of reaction gases with catalysts via internal reactors;
a heater having different temperature zones sectioned according to respective synthetic steps of carbon nanotubes and simultaneously providing reaction temperatures for the respective steps necessary for synthesis of carbon nanotubes to the reaction chambers;
a driving device for driving the heater such that positions of the temperature zones for the respective synthesis steps of the heater are moved to the corresponding reaction chambers of the respective synthesis steps, and for moving the heater at a predetermined interval of time in compliance with progress of the synthesis steps such that carbon nanotubes are continuously synthesized in respective reaction chambers; and
gas supply and discharge section for supplying and discharging reaction gases corresponding to respective synthesis steps to and from internal reactors of the respective reaction chambers in compliance with movement control of the driving device according to the respective synthesis steps.

2. The apparatus according to claim 1, wherein the heater is composed of at least one low-temperature zone, at least one reaction zone and at least one cooling zone, providing reaction temperatures corresponding to respective synthesis steps to respective corresponding reaction chambers.

3. The apparatus according to claim 2, wherein the reaction chambers include gas diffusion ports receiving reaction gases through lower connection parts of the reaction chambers and diffusing the reaction gases at the lower parts of the reaction chambers, the reaction gases being supplied via gas supply and discharge sections; and
gas exhaust ports for sucking and exhausting the reaction gases, installed at upper and lower parts of the reaction chambers, in order to discharge the reaction gases to the outside through the gas supply and discharge sections.

4. The apparatus according to claim 3, wherein the low-temperature zone, reaction zone and cooling zone of the heater supply a temperature of 200 to 700° C., a temperature of 800 to 1000° C., and a temperature of 700 to 200° C. to corresponding reaction chambers.

5. An apparatus for mass production of carbon nanotubes, comprising:
a plurality of reaction chambers where synthesis of carbon nanotubes is performed by reaction of reaction gases with catalysts via internal reactors;
a heater having different temperature zones sectioned according to respective synthesis steps of carbon nanotubes and simultaneously providing reaction temperatures for the respective synthesis steps necessary for synthesis of carbon nanotubes to the reaction chambers;
a driving device for driving the reaction chambers such that positions of the reaction chambers are moved to temperature zones of the heater corresponding to the internal synthesis steps, and for moving the reaction chambers at a predetermined interval of time in compliance with progress of the synthesis steps such that carbon nanotubes are continuously synthesized in respective reaction chambers; and
gas supply and discharge sections for supplying and discharging reaction gases corresponding to respective synthesis steps to and from internal reactors of the respective reaction chambers, in compliance with movement control of the driving device according to the respective synthesis steps.

6. The apparatus according to claim 5, wherein the heater is composed of at least one low-temperature zone, at least one reaction zone and at least one cooling zone, providing reaction temperatures corresponding to respective synthesis steps to respective corresponding reaction chambers.

7. The apparatus according to claim 6, wherein the reaction chambers includes gas diffusion ports receiving reaction gases through lower connection parts of the reaction chambers and diffusing the reaction gases at the lower parts of the reaction chambers, the reaction gases being supplied via gas supply and discharge sections; and
gas exhaust ports for sucking and exhausting the reaction gases, installed at upper and lower parts of the reaction chambers, in order to discharge the reaction gases to the outside through the gas supply and discharge sections.

8. The apparatus according to claim 7, wherein the low-temperature zone, reaction zone and cooling zone of the heater supply a temperature of 200 to 700° C., a temperature of 800 to 1000° C., and a temperature of 700 to 200° C. to corresponding reaction chambers.

9. A method for mass production of carbon nanotubes, comprising:
driving a heater composed of at least one low-temperature zone, at least one reaction zone and at least one cooling zone to move the positions of low-temperature zones of the heater to corresponding reaction chambers, and subjecting the corresponding reaction chambers to argon atmosphere using argon gas prepared in a gas mixer to thereby discharge internal air to the outside (preheating step);
driving the heater to move the positions of high-temperature zones thereof to corresponding reaction chambers, and replacing the argon gas in the reaction chambers with carbonization gas prepared in the gas mixer to synthesize carbon nanotubes via reaction between the carbonization gas and catalyst (reaction step); and
driving the heater to move the positions of the cooling zones thereof to the corresponding reaction chambers, and discharging the remaining gas in the chambers to the outside by action of argon gas prepared in the gas mixer and cooling the synthesized carbon nanotubes in reaction chambers (cooling step).

10. The method according to claim 9, wherein, upon performing the respective synthesis steps, the respective zones of the heater move to positions of different reaction chambers under any one synthesis step of preheating, reaction and cooling steps, thereby simultaneously providing reaction temperatures corresponding to respective synthesis steps to the different reaction chambers.

11. The method according to claim 10, wherein, upon supplying and discharging gases to and from the reaction chambers, gases supplied to the reaction chambers via lower connection parts thereof are diffused at the lower parts of the reaction chambers, and gases to be discharged to the outside are exhausted simultaneously at upper and lower parts of the reaction chambers.

12. The method according to claim 11, wherein the low-temperature zone, reaction zone and cooling zone of the heater supply a temperature of 200 to 700° C., a temperature of 800 to 1000° C., and a temperature of 700 to 200° C. to corresponding reaction chambers.

13. A method for mass production of carbon nanotubes, comprising:
driving reaction chambers to move the positions thereof to low-temperature zones of a heater composed of at least one low-temperature zone, at least one reaction zone and at least one cooling zone, and subjecting the corresponding reaction chambers to argon atmosphere using argon gas prepared in a gas mixer to thereby discharge internal air to the outside (preheating step);
driving the reaction chambers to move the positions thereof to high-temperature zones of the heater, and replacing the argon gas in the reaction chambers with carbonization gas prepared in the gas mixer to synthesize carbon nanotubes via reaction between the carbonization gas and catalyst (reaction step); and
driving the reaction chambers to move the positions thereof to the cooling zones of the heater, and discharging the remaining gas in the chambers to the outside by action of argon gas prepared in the gas mixer and cooling the synthesized carbon nanotubes in reaction chambers (cooling step).

14. The method according to claim 13, wherein, upon performing the respective synthesis steps, different reaction chambers under any one synthesis step of preheating, reaction and cooling steps move to positions of the respective zones of the heater, thereby simultaneously receiving reaction temperatures corresponding to respective synthesis steps.

15. The method according to claim 14, wherein, upon supplying and discharging gases to and from the reaction chambers, gases supplied to the reaction chambers via lower connection parts thereof are diffused at the lower parts of the corresponding reaction chambers, and gases to be discharged to the outside of the reaction chambers are exhausted simultaneously at upper and lower parts thereof.

16. The method according to claim 15, wherein the low-temperature zone, reaction zone and cooling zone of the heater supply a temperature of 200 to 700° C., a temperature of 800 to 1000° C., and a temperature of 700 to 200° C. to corresponding reaction chambers.
